(19) United States
(12) Patent Application Publication
(10) Pub. No.: US 2014/0222583 A1
(43) Pub. Date: Aug. 7, 2014

(54) DETERMINING VALUES FOR A CHARACTERISTIC OF AN ONLINE SYSTEM USER BASED ON A REFERENCE GROUP OF USERS

(71) Applicant: Facebook, Inc., Menlo Park, CA (US)

(72) Inventors: William Bullock, Palo Alto, CA (US); Sean Michael Bruich, Palo Alto, CA (US)

(73) Assignee: Facebook, Inc., Menlo Park, CA (US)

(21) Appl. No.: 13/759,976

(22) Filed: Feb. 5, 2013

(51) Int. Cl. G06Q 30/02

(52) U.S. Cl. CPC G06Q 30/0269
USPC 705/14.66

(57) ABSTRACT

An online system predicts values of a target characteristic for users in a set of users based on a reference set of users having known values for the target characteristic. Using descriptive characteristics of users in the reference set of users and target characteristic values for users in the reference set, the online system generates a model predicting values of the target characteristic based on user descriptive characteristics. The online system applies a global constraint on the target characteristic when generating the model, so the model extrapolates from the reference data while achieving aggregate results for values of the target characteristic that are consistent with the global constraint. The global constraint may be obtained from census data or another suitable global aggregate survey. Using the global constraint in the model avoids inaccuracies in reporting of user metrics.

### BACKGROUND

The present disclosure relates to online systems, and in particular to inferring a target characteristic of a set of users of the online system based on characteristics of a reference group of users of the online system.

A social networking system allows its users to connect with and to communicate with other users of the social networking system, which may be individual users or entities such as corporations or charities. To encourage exchange of information between users, a social networking system often maintains objects such as applications, events, and pages. The increasing popularity of social networking systems and number of objects maintained by social networking systems make social networking systems an ideal forum for entities to advertise products or services offered.

Advertisers compensate a social networking system for presenting advertisements to users, and revenue from advertisement presentation is a significant revenue stream for many social networking systems. Because a social networking system includes a variety of information about its users, advertisers may leverage this information to direct advertisements to specific social networking system users, increasing the likelihood of the specific users interacting with the advertisement or purchasing advertised products or services. Using information maintained by a social networking system to direct advertisements to specific social networking system users allows advertisers to present users with advertisements perceived to be more relevant, which increases the conversion rate of users viewing the advertisement. This increased conversion rate also increases the amount advertisers are willing to pay a social networking system for presenting advertisements.

Conventionally, consumer data, such as websites visited or content viewed, is used target ads. For example, if a user frequently visits websites about cars, the user may be targeted with a car related advertisement. Additionally, an advertiser may further specify targeting criteria specifying characteristics of users eligible to be presented with an advertisement and uses information associated with users by a social networking system to identify users satisfying one or more of the characteristics. However, a social networking system often has incomplete or inaccurate information associated with a user (collectively “missing values”) for determining if users satisfy targeting criteria; for example, the social networking system may not include a user's age. Conventionally, consumer data is used to estimate missing information values for a user.

However, using consumer data to estimate missing values does not typically account for other information affecting the ability of a user to provide revenue to an advertiser through purchases or other actions. Additionally, basing estimation of missing values on online activity without other information may provide inaccurate results. Hence, conventional techniques for estimating information about a user that is not provided by the user may cause inaccurate identification of advertisements presented to the user.

### SUMMARY

An online system predicts values of a target characteristic for users in a set of users based on a reference group of users having known values for the target characteristic. Using descriptive characteristics of users in the reference group of users and target characteristic values for users in the reference set, the online system generates a model predicting values of the target characteristic based on user descriptive characteristics. The online system applies one or more constraints on the target characteristic when generating the model, so the model extrapolates from the reference data while achieving aggregate results for values of the target characteristic that are consistent with the constraint. For example, a constraint specifies a maximum number of users having a specific value for the target characteristic or specifies an average value for the target characteristic. The constraint may be obtained from information associated with a population of users that includes a larger number of users than the reference group. For example, the constraint is obtained from census data or another suitable survey aggregating global information describing users of the online system. Using the constraint in the model avoids inaccuracies in reporting of user metrics.

In one embodiment, the generated model associates weights with each user in the reference group. The weight associated with a user may be based on a likelihood of the user being included in the reference group conditional on descriptive characteristics associated with the user. For example, the weight is the inverse of the likelihood of the user being included in the reference group conditioned on descriptive characteristics associated with the user. The weights may be modified to allow the reference group to more accurately represent descriptive characteristics of the set of users.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a flowchart of a process for determining values of a target characteristic for various users in a set of online system users, in accordance with an embodiment.

FIG. 4A is an example of information describing a set of users having incomplete information associated with a target characteristic, in accordance with an embodiment.

FIG. 4B is an example of information describing a reference group of users having values associated with a target characteristic, in accordance with an embodiment.

The figures depict various embodiments of the present disclosure for purposes of illustration only. One skilled in the art will readily recognize from the following discussion that alternative embodiments of the structures and methods illustrated herein may be employed without departing from the principles of the embodiments described herein.

### DETAILED DESCRIPTION

### System Architecture

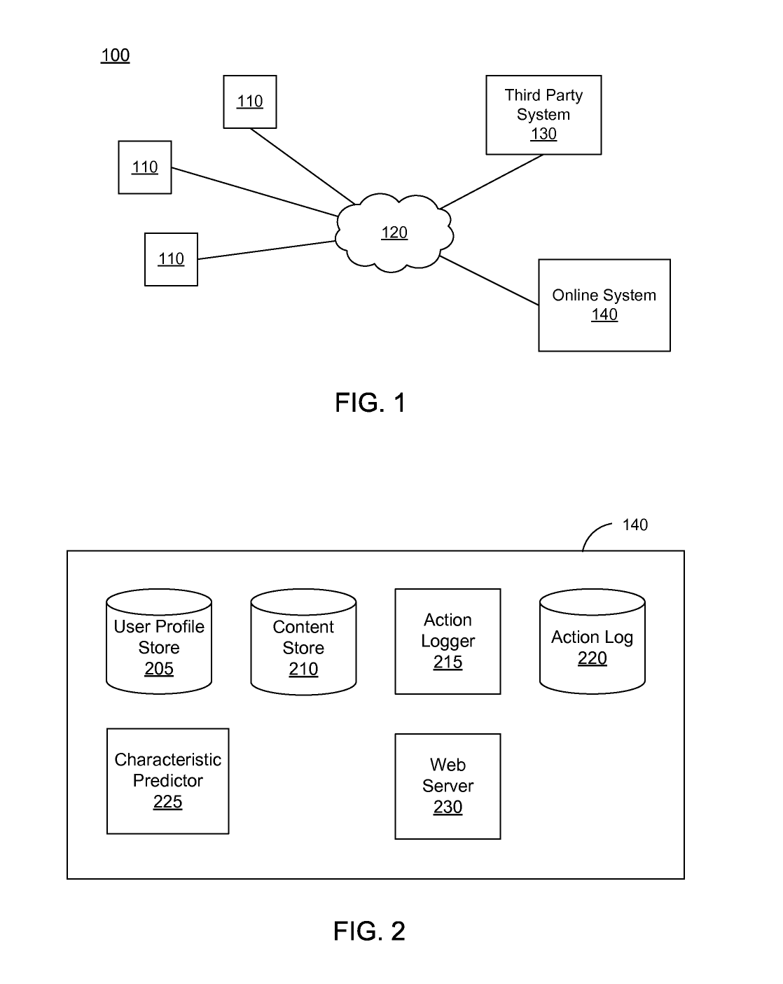

FIG. 1 is a high level block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. The embodiments described herein can be adapted to online systems that are not online systems.

The client devices 110 are one or more computing devices capable of receiving user input as well as transmitting and/or receiving data via the network 120. In one embodiment, a client device 110 is a conventional computer system, such as a desktop or laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party website 130 may also communicate information to the online system 140, such as advertisements, content, or information about an application provided by the third party website 130.

FIG. 2 is an example block diagram of an architecture of the online system 140. The online system 140 shown in FIG. 2 includes a user profile store 205, a content store 210, an action logger 215, an action log 220, a characteristic predictor 225, and a web server 230. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes descriptive information about the user that was explicitly shared by the user, and may also include profile information inferred by the online system 140. In one embodiment, a user profile includes multiple data fields, each data field describing one or more attributes of the corresponding user of the online system 140. Examples of information stored in a user profile include biographic, demographic, and other types of descriptive information, such as work experience, educational history, gender, hobbies or preferences, location and the like. A user profile may also store other information provided by the user, for example, images or videos. In some embodiments, a user profile may include information describing one or more relationships between a user and other online system users. A user profile in the user profile store 205 may also maintain references to actions performed by the corresponding user and stored in the action log 220.

The content store 210 stores objects each representing various types of content. Examples of content represented by an object include a page post, a status update, a photo, a video, a link, a shared content item, a gaming application achievement, a check-in event at a local business, a brand page, or any other type of content. Objects may be created by users of the online system 140, such as status updates, photos tagged by users to be associated with other objects in the online system, events, groups or applications. In some embodiments, objects are received from third-party applications or third-party applications separate from the online system 140. Content “items” represent single pieces of content that are represented as objects in the online system 140.

In some embodiments, the online system 140 records actions performed by its users to augment the descriptive information associated with the user in a corresponding user profile. For example, the action logger 215 receives communications about user actions on and/or off the online system 140, populating the action log 220 with information about user actions. Such actions may include, for example, adding a connection to another user, sending a message to another user, uploading an image, reading a message from another user, viewing content associated with another user, attending an event posted by another user, among others. In addition, some actions described in connection with other objects are directed at particular users, so these actions are associated with those users as well. These actions are stored in the action log 220.

The action log 220 may be used by the online system 140 to track user actions on the online system 140, as well as third party systems 130 that communicate information to the online system 140. Users may interact with various objects on the online system 140, including commenting on posts, sharing links, accessing content items, or other interactions. Information describing these actions is stored in the action log 220. Additionally, the action log 220 records a user's interactions with advertisements presented by the online system 140 as well as other applications operating on the online system 140. In some embodiments, data from the action log 220 is used to infer interests or preferences of the user, augmenting the interests included in the user profile and allowing a more complete understanding of user preferences and characteristics.

The action log 220 may also store user actions taken on a third party system 130, such as an external website. For example, an e-commerce website that primarily sells sporting equipment at bargain prices may recognize a user of an online system 140 through plug-ins that enable the e-commerce website to identify the user of the online system 140. Because users of the online system 140 are uniquely identifiable, e-commerce websites, such as this sporting equipment retailer, may use the information about these users as they visit their websites. The action log 220 records data about these users, including webpage viewing histories, advertisements that were engaged, purchases made, and other patterns from shopping and buying.

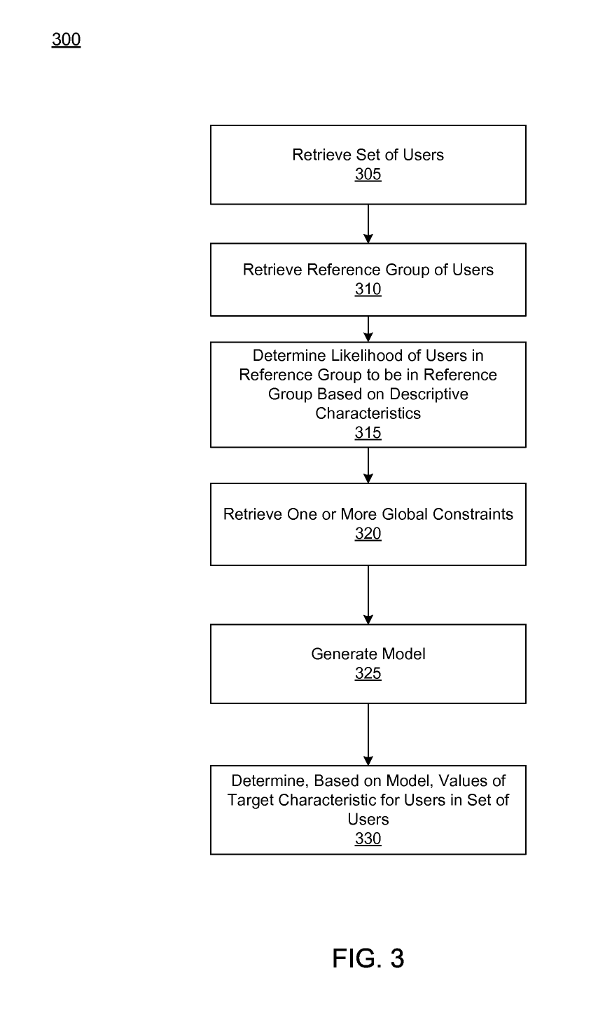

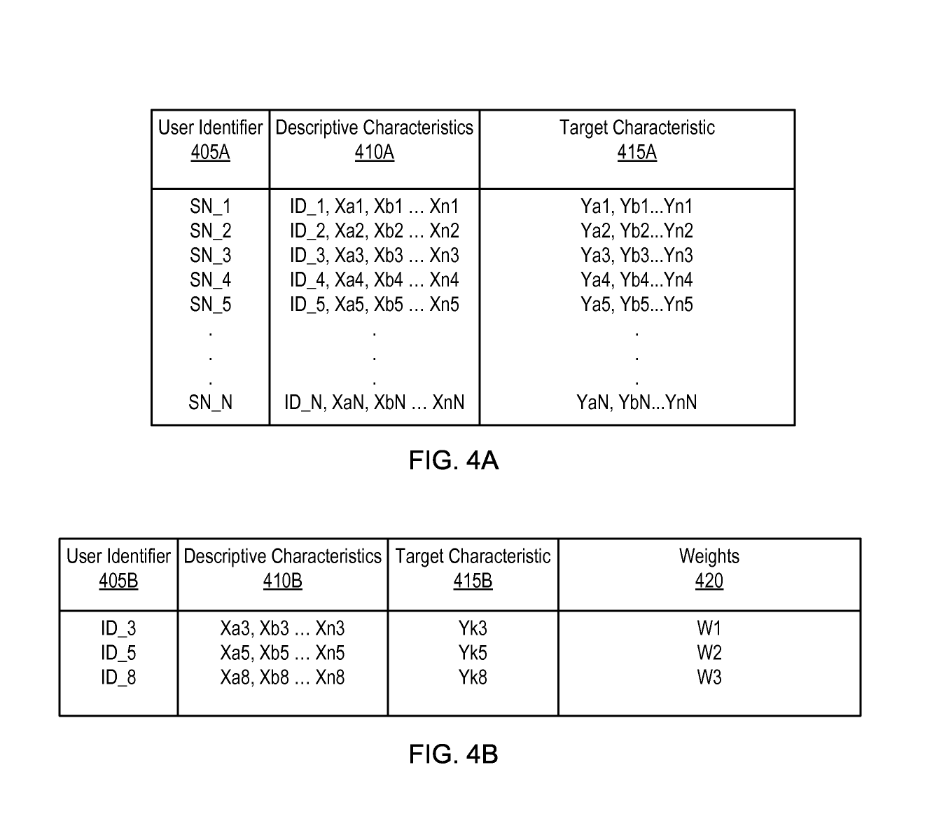

The characteristic predictor 225 determines one or more values for a target characteristic associated with an online system user. For example, the characteristic predictor 225 determines a value of a characteristic that is not included in a user profile, the value of a characteristic for which the user did not include a value in the user profile, or the value of a characteristic for which inaccurate or incomplete information is stored in the user profile. In one embodiment, the characteristic predictor 225 determines values for a target characteristic for a set of users that do not have a value associated with the target characteristic based on a reference group of users having known values for the target characteristic. Using descriptive information associated with the users in the reference group and the corresponding values for the target characteristic, the characteristic predictor 225 generates a model for predicting values of the target characteristic for users in the set of users. Additionally, the model enforces one or more constraints on the values for the target characteristic predicted for users in the set of users so an aggregation of values for the target characteristic satisfies a constraint. The constraint may be determined from global information about the set of users or about a larger group of users including the set of users. Operation of the characteristic predictor 225 is further described below in conjunction with FIGS. 3-4B.

The web server 230 links the online system 140 via the network 120 to the one or more client devices 110, as well as to the one or more third party systems 130. The web server 140 serves web pages, as well as other web-related content, such as JAVA®, FLASH®, XML and so forth. The web server 230 may receive and route messages between the online system 140 and the client device 110, for example, instant messages, queued messages (e.g., email), text messages, short message service (SMS) messages, or messages sent using any other suitable messaging technique. A user may send a request to the web server 230 to upload information (e.g., images or videos) that are stored in the content store 210. Additionally, the web server 230 may provide application programming interface (API) functionality to send data directly to native client device operating systems, such as IOS®, ANDROID™, WEBOS® or RIM®. Determining a Value for a Target Characteristic Based on a Reference Group of Users

FIG. 3 is a flowchart of one embodiment of a process 300 for determining values of a target characteristic for various users in a set of users of an online system 140. In one embodiment, the functionality described in conjunction with FIG. 3 is performed by the characteristic predictor 225 of the online system 140. However, in other embodiments, the functionality may be provided by any suitable component or by multiple components.

Information describing a set of users is retrieved 305. The set of users includes users that do not have a value for a target characteristic or users for which inaccurate or incomplete values are associated with the target characteristics. FIG. 4A shows an example of retrieved information describing the set of users. In the example of FIG. 4A, the set of users are each users of the online system 140 and associated with an online system user identifier 405A. For example, the online system user identifier 405A uniquely identifies user profiles from the user profile store 205 corresponding to various users. Descriptive characteristics 410A from a user profile are retrieved 305 and associated with the user profile corresponding to the online system user identifier 405A. Examples of descriptive characteristics 410A retrieved from a user profile include age, geographic location, occupation, education history, salary, e-mail address, phone number, address, contact information, or other information describing a user. In one embodiment, the online system 140 is a social networking system, so the descriptive characteristics 410A may include social information about a user (e.g., connections to other users, actions performed by the user, etc.).

A reference group of users, which includes a fewer number of users than the set of users, is identified and information describing users in the reference group is retrieved 310. Users in the reference group have a value associated with the target characteristic. In one embodiment, the values associated with the target characteristic for users in the reference group have been determined to be accurate or otherwise verified. The reference group may be a subset of the set of users or may be retrieved 310 from another source, such as a third party system 130.

The reference group of users may be retrieved 310 by presenting users of the online system 140 with a survey prompting the users to provide a value for the target characteristic. For users providing a value for the target characteristic, descriptive characteristics are retrieved and associated with a user identifier and with the received value for the target characteristic. Alternatively, the reference group of users may be retrieved 310 from a third party system 130 and information retrieved 310 from the third party system 130 may be used to obtain descriptive characteristics for users in the reference group maintained by the online system 140, as described below.

FIG. 4B shows an example of retrieved information describing users in the reference group. In the example of FIG. 4B, each user in the reference group is associated with a user identifier 405B, descriptive characteristics 410B, and known values for the target characteristic 415B. The descriptive characteristics 410B describe users included in the set of users. For example, the descriptive characteristics 410A for the set of users and the descriptive characteristics 410B for the reference group of users each include an e-mail address, an occupation, a geographic location, a salary, and an education history. In one embodiment, a portion of the descriptive characteristics 410B for users in the reference group is retrieved from the online system 140. For example, the descriptive characteristics 410B for users in the reference group include an identifying characteristic, such as an e-mail address, which is communicated to the online system 140. The online system 140 retrieves additional descriptive characteristics from a user profile corresponding to the identifying characteristic. Referring to FIG. 4B, the user identifier “ID_{—}3” corresponding to a user in the reference group is provided to the online system, which retrieves “Xa3, Xb3 . . . Xn3” from a user profile including a characteristic of “ID_{—}3.”

In one embodiment, likelihoods of each user in the reference group being included in the reference group conditional on the descriptive characteristics 410B associated with the users are determined 315. A determined likelihood for a user may be used to associate a weight 420 with the user based on inverse probability weighting. In one embodiment, the likelihoods are determined 315 using logistic regression. For example, a weight 420 associated with a user is the inverse of the probability of the user being in the representative group of users conditioned on the descriptive characteristics 410B associated with the user. The weights 420 are used to provide a degree of similarity between the descriptive characteristics 410B associated with users in the reference group and the descriptive characteristics 410A associated with users in the set of users. Hence, the weights 420 may be adjusted to account for discrepancies between descriptive characteristics 410A of users in the set of users and descriptive characteristics 410B of users in the reference group.

One or more constraints associated with the target characteristic are retrieved 320 and used along with descriptive characteristics 410B of users in the reference group to generate 325 a model predicting values for the target characteristics based on a user's descriptive characteristics. A constraint associated with the target characteristic limits one or more values of the target characteristic and is based on a population of users that includes a greater number of users than the reference group. In one embodiment, the population of users includes users in the reference group and in the set of users. In another embodiment, the population of users includes a greater number of users than the aggregate number of users in the reference group and in the set of users. The one or more constraints may be obtained from analysis of the set of users, analysis of the population of users including more users than the set of users and the additional users, retrieved from a third party system 130, or obtained from any other suitable source. Additionally, a constraint may be retrieved 320 by analyzing global information associated with all users of the online system 140 or by analyzing information about a population including users of the online system 140. In one embodiment, a constraint limits the aggregate number of users having a value associated with the target characteristic. For example, a constraint specifies a total number of users having a particular value for the target characteristic. As another example, a constraint specifies a mean value for the target characteristic for multiple users. Accounting for the one or more constraints allows the model to provide aggregate data matching the information used to determine the one or more constraints, providing more accurate estimation of target characteristic values for larger numbers of users.

In one embodiment, the model is a multinomial probit model that generates coefficients for different descriptive characteristics based on an assumption the descriptive characteristics are related in some degree to producing a value for the target characteristic associated with a user in the reference group. In various embodiments, the model may include an initial value and an error term as well as various descriptive characteristics. In some embodiments, the generated model is modified based on the likelihoods of each user in the reference group being included in the reference group conditional on the descriptive characteristics 410B. For example, coefficients in the multinomial probit model may be increased or decreased to offset underrepresentation and overrepresentation, respectively, of descriptive characteristics in the reference group.

The model is applied to descriptive characteristics 410A of users in the set of users to determine 330 imputed values for the target characteristic 415A for users in the set of users. In one embodiment, application of the model determines 330 a histogram of probabilities of the target characteristic having different imputed values for a user based on the user's descriptive characteristics 410A. For example, if the target characteristic is a model of car, the model determines 330 probabilities of the target characteristic of a user being different models of car based on application of the model to the user's descriptive characteristics 410A. As another example, application of the model determines 330 a probability distribution of imputed values for the target characteristic 415A around a mean value. In some embodiments, the model is applied to the descriptive characteristics 410A of users in the set of users at periodic intervals or responsive to interactions with the online system 140. This allows the determined 330 imputed values of the target characteristics 415A to be updated based on changes to the descriptive characteristics 410A over time.

Alternatively, the model is applied to the descriptive characteristics 410A to determine 330 values for the target characteristic for users in the set of users. The one or more constraints are applied to the determined values. For example, a total number of users having a specified value for the target characteristic imputed by the model is determined and compared to a constraint. If the total number of users having the specified value imputed by the model deviates from the constraint by more than a threshold amount, the model is modified. For example, an error term in the model is modified based on the difference between the constraint and the total number of users in the population having the specified value imputed by the model. The modified model is used to determine 330 values for the target characteristic for users in the set of users and the preceding comparison and modification is repeated until the difference between the constraint and the number of users having the specified value for the target characteristic does not exceed the threshold.

The values of the target characteristic determined 330 from application of the model may be provided from the online system 140 to a third party system 130 to provide metrics describing online system users. Additionally, the determined values of the target characteristics may be used in conjunction with targeting criteria associated with advertisements, allowing the online system 140 to provide additional information for more specific targeting of advertisements. For example, determined values for a target characteristic may be compared to targeting criteria for an advertisement allowing users that have not provided a value for the target characteristic to potentially be eligible to be presented with the advertisement rather than be ineligible for being presented with the advertisement based on the lack of target characteristic value.

### SUMMARY

The foregoing description of the embodiments has been presented for the purpose of illustration; it is not intended to be exhaustive or to limit the disclosure to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the embodiments be limited not by this detailed description, but rather by any claims that issue on an application based hereon. Accordingly, the disclosure of the embodiments is intended to be illustrative, but not limiting, of the scope of the disclosure, which is set forth in the following claims.

What is claimed is:

1. A method comprising:
retrieving a reference group of users of an online system each having a known value associated with a target characteristic and associated with one or more other descriptive characteristics;
retrieving one or more constraints associated with the target characteristic based on a population of users including a greater number of users than the reference group;
generating a model from the one or more descriptive characteristics of the retrieved reference group of users each having information associated with the target characteristic, the model determining a value of the target characteristic for each of the individual users in the population subject to a condition that the target characteristic aggregated across the population satisfies a constraint; and
determining imputed values for the target characteristic for one or more users of the online system not included in the reference group by applying the model to descriptive characteristics associated with each of the one or more users.

2. The method of claim 1, wherein the population of users includes users in the reference group and additional users of the online system not in the reference group.

3. The method of claim 1, wherein retrieving one or more constraints associated with the target characteristic comprises:
receiving a constraint on at least one of the values for the target characteristic from a third party system.

4. The method of claim 1, wherein the population of users includes all users of the online system.

5. The method of claim 1, wherein determining imputed values for the target characteristic for one or more users of the online system not included in the reference group by applying the model to descriptive characteristics associated with each of the one or more users comprises:
determining probabilities of the target characteristic for a user having different values from a set of values by applying the model to descriptive characteristics associated with the user.

6. The method of claim 1, wherein determining imputed values for the target characteristic for one or more users of the online system not included in the reference group by applying the model to descriptive characteristics associated with each of the one or more users comprises:
determining a probability distribution of values for the target characteristic for a user around a mean value by applying the model to descriptive characteristics associated with the user.

7. The method of claim 1, wherein retrieving the reference group of users of the online system each having the known value associated with the target characteristic and associated with descriptive characteristics comprises:
presenting a survey to users in of the online system, the survey prompting a user to specify a value for the target characteristic;
receiving values for the target characteristic from one or more users presented with the survey; and
retrieving descriptive characteristics associated with each user from which a value for the target characteristic was received.

8. The method of claim 1, wherein generating the model from the descriptive characteristics of the retrieved reference group of users each having information associated with the target characteristic comprises:
determining, for each user in the reference group, a weight based on a likelihood of a user being included in the reference group conditional on descriptive characteristics associated with the user.

9. The method of claim 8, wherein the weight for the user in the reference group comprises an inverse of the likelihood of the user being included in the reference group conditional on descriptive characteristics associated with the user.

10. The method of claim 1, further comprising:
determining a number of the one or more users of the online system not included in the reference group for which the target characteristic was determined to have a specified imputed value; and
modifying the model if a difference between a constraint and the determined number of the one or more users of the online system not included in the reference group for which the target characteristic was determined to have the specified imputed value exceeds a threshold.

11. A method comprising:
retrieving a set of users of an online system each associated with descriptive characteristics and each having incomplete information for a target characteristic;
retrieving a reference group of users of the online system each having a known value associated with the target characteristic and associated with descriptive characteristics;
retrieving one or more constraints associated with the target characteristic based on a population of users including a greater number of users than the reference group;
generating a model from the descriptive characteristics of the retrieved reference group of users each having information associated with the target characteristic, the model determining a value of the target characteristic for each of the individual users in the population subject to a condition that the target characteristic aggregated across the population satisfies a constraint; and
determining imputed values for the target characteristic for users in the set of users and not included in the reference group by applying the model to descriptive characteristics associated with users in the set of users.

12. The method of claim 11, further comprising:
determining a number of the one or more users in the set of users and not included in the reference group for which the target characteristic was determined to have a specified imputed value; and
modifying the model if a difference between the constraint and the determined number of the one or more users of the online system not included in the reference group for which the target characteristic was determined to have the specified value exceeds a threshold.

13. The method of claim 11, wherein the reference group includes a number of users less than a total number of users in the set of users.

14. The method of claim 11, wherein retrieving one or more constraints associated with the target characteristic comprises:
determining a constraint based on information associated with users in the population of users.

15. The method of claim 11, wherein retrieving one or more constraints associated with the target characteristic comprises:
receiving a constraint on at least one of the values for the target characteristic from a third party system.

16. The method of claim 11, wherein retrieving one or more constraints associated with the target characteristic comprises:
determining a constraint based on analysis of global information associated with all users of the online system.

17. The method of claim 11, wherein determining values for the target characteristic for one or more users of the online system not included in the reference group by applying the model to descriptive characteristics associated with each of the one or more users comprises:
determining probabilities of the target characteristic for a user having different values from a set of values by applying the model to descriptive characteristics associated with the user.

18. The method of claim 11, wherein determining values for the target characteristic for one or more users of the online system not included in the reference group by applying the model to descriptive characteristics associated with each of the one or more users comprises:
determining a probability distribution of values for the target characteristic for a user around a mean value by applying the model to descriptive characteristics associated with the user.

19. The method of claim 11, wherein generating the model from the descriptive characteristics of the retrieved reference group of users each having information associated with the target characteristic comprises:
determining, for each user in the reference group, a weight based on a likelihood of a user being included in the reference group conditional on descriptive characteristics associated with the user.

20. The method of claim 19, wherein the weight for the user in the reference group comprises an inverse of the likelihood of the user being included in the reference group conditional on descriptive characteristics associated with the user.
